(19) United States
(12) Patent Application Publication
(10) Pub. No.: US 2024/0104461 A1
(43) Pub. Date: Mar. 28, 2024

(54) MANAGEMENT APPARATUS, MANAGEMENT METHOD, AND STORAGE MEDIUM

(71) Applicant: HONDA MOTOR CO., LTD., TOKYO (JP)

(72) Inventors: Daisuke INOUE, TOKYO (JP); Toshikatsu KURAMOCHI, TOKYO (JP)

(21) Appl. No.: 18/372,117

(22) Filed: Sep. 24, 2023

(30) Foreign Application Priority Data
Sep. 26, 2022 (JP) 2022-152058
Jul. 26, 2023 (JP) 2023-121187

(51) Int. Cl. G06Q 10/0631; G06Q 10/02; G06Q 10/10; G06Q 50/14

(52) U.S. Cl. CPC G06Q 10/06313; G06Q 10/02; G06Q 10/103; G06Q 50/14

(57) ABSTRACT

A management apparatus includes: a desired operation route information acquisition unit that acquires desired operation route information indicating a desired operation route that is an operation route desired by an applicant who wishes to use an aircraft; and an operation plan acquisition unit that acquires an operation plan for the aircraft generated based on a plurality of pieces of the desired operation route information.

### CROSS-REFERENCE TO RELATED APPLICATIONS

This application is based upon and claims the benefit of priority from Japanese Patent Applications No. 2022-152058 filed on Sep. 26, 2022, and No. 2023-121187 filed on Jul. 26, 2023, the contents all of which are incorporated herein by reference.

### BACKGROUND OF THE INVENTION

### Field of the Invention

The present invention relates to a management apparatus, a management method, and a storage medium.

### Description of the Related Art

JP 6183970 B2 discloses a technique related to optimization of an airline on which an aircraft travels.

### SUMMARY OF THE INVENTION

Relatively small aircraft, also referred to as business jets, are known. The business jet provides non-scheduled air service in response to a request of an owner. In recent years, there has been a demand for techniques that contribute to the widespread use of aircraft including small aircraft such as business jets.

An object of the present invention is to solve the above-mentioned problem.

According to a first aspect of the present invention, there is provided a management apparatus comprising: a desired operation route information acquisition unit configured to acquire desired operation route information indicating a desired operation route that is an operation route desired by an applicant who wishes to use an aircraft; and an operation plan acquisition unit configured to acquire an operation plan for the aircraft generated based on a plurality of pieces of the desired operation route information.

According to a second aspect of the present invention, there is provided a management method executed by a computer, the method comprising: acquiring desired operation route information indicating a desired operation route that is an operation route of an aircraft desired by an applicant who wishes to use the aircraft; and acquiring an operation plan for the aircraft generated based on a plurality of pieces of the desired operation route information.

According to a third aspect of the present invention, there is provided a non-transitory computer-readable storage medium that stores a program for causing a computer to execute the above-described management method.

According to the present invention, it is possible to contribute to the widespread use of aircraft.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram illustrating a management system according to a first embodiment;

FIG. 2 is a flowchart illustrating a management method according to the first embodiment;

FIG. 3 is a block diagram illustrating a management system according to a second embodiment;

FIG. 4A is a diagram illustrating an example of a candidate operation plan generated by a candidate operation plan generation unit;

FIG. 4B is a diagram illustrating another example of the candidate operation plan generated by the candidate operation plan generation unit; and

FIG. 5 is a flowchart illustrating a management method according to the second embodiment.

### DETAILED DESCRIPTION OF THE INVENTION

### First Embodiment

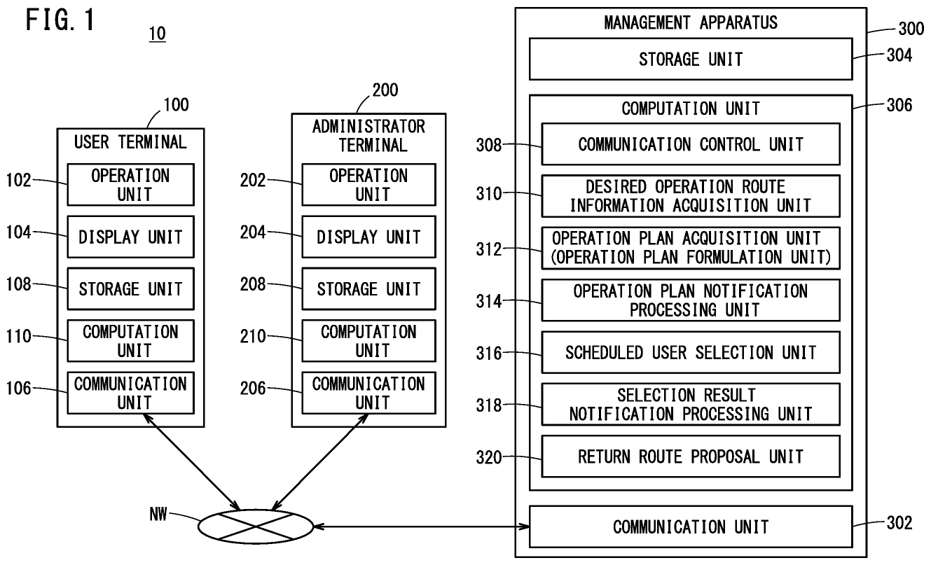

FIG. 1 is a block diagram illustrating a management system 10 according to the present embodiment.

The management system 10 is a system for performing operation management of an aircraft (not illustrated in the present embodiment, see also an aircraft 400 according to a second embodiment) that is operated on an irregular basis. The aircraft is, for example, a small jet aircraft having a capacity of four to six passengers, but is not limited thereto. The management system 10 includes a user terminal 100, an administrator terminal 200, and a management apparatus 300. The number of the user terminals 100 is not particularly limited. Therefore, a plurality of the user terminals 100 may be included in the management system 10.

The user terminal 100 is a terminal used by a user who uses the management system 10 (an applicant who wishes to use the management system 10, a scheduled user who is scheduled to use the management system 10). The user terminal 100 is, for example, a smartphone, a tablet terminal, a personal computer (PC), or the like. The user terminal 100 includes an operation unit 102, a display unit 104, a communication unit 106, a storage unit 108, and a computation unit (control unit) 110.

The operation unit 102 receives an input operation performed by the user on the user terminal 100. The display unit 104 includes a display element (not illustrated). The display element is, for example, a liquid crystal display element, an organic electroluminescence display element, or the like. At least a part of the operation unit 102 and the display unit 104 may be constituted by a touch panel (not illustrated) provided with such a display element.

The communication unit 106 includes, for example, a communication module (not illustrated). The communication unit 106 is connected to a network NW. The network NW is, for example, the Internet.

The storage unit 108 may include a volatile memory (not illustrated) and a non-volatile memory (not illustrated). Examples of the volatile memory include a random access memory (RAM). Examples of the non-volatile memory include a read only memory (ROM) and a flash memory.

The computation unit 110 may be constituted by a processor such as a central processing unit (CPU) or a graphics processing unit (GPU). That is, the computation unit 110 may be constituted by processing circuitry. The computation unit 110 can control the entire user terminal 100 based on a program stored in the storage unit 108. The computation unit 110 can control the user terminal 100 in accordance with an operation performed by the user using the operation unit 102. For example, the display unit 104 and the communication unit 106 described above are controlled by the computation unit 110. By the computation unit 110 controlling the display unit 104, for example, data stored in the storage unit 108 is appropriately displayed on the display unit 104. By the computation unit 110 controlling the communication unit 106, the user terminal 100 can communicate with the management apparatus 300 via the network NW.

The administrator terminal 200 is a terminal used by an administrator who manages the operation of the aircraft. The administrator is, for example, a person belonging to an operation management company that manages the operation of the aircraft. The administrator terminal 200 is, for example, a personal computer. However, the administrator terminal 200 may be a smartphone, a tablet terminal, or the like. The administrator terminal 200 includes an operation unit 202, a display unit 204, a communication unit 206, a storage unit 208, and a computation unit (control unit) 210.

The operation unit 202 receives an input operation performed by the administrator on the administrator terminal 200. The operation unit 202 is, for example, a keyboard, a mouse, or the like, but is not limited thereto. The display unit 204 includes a display element (not illustrated). The display element is, for example, a liquid crystal display element, an organic electroluminescence display element, or the like. At least a part of the operation unit 202 and the display unit 204 may be constituted by a touch panel (not illustrated) provided with such a display element.

The communication unit 206 includes, for example, a communication module (not illustrated). The communication unit 206 is connected to the network NW.

The storage unit 208 may include a volatile memory (not illustrated) and a non-volatile memory (not illustrated). Examples of the volatile memory may include a RAM and the like. Examples of the non-volatile memory may include a ROM, a flash memory, and the like.

The computation unit 210 may be constituted by a processor such as a CPU or a GPU. That is, the computation unit 210 may be constituted by processing circuitry. The computation unit 210 can control the entire administrator terminal 200 based on a program stored in the storage unit 208. The computation unit 210 can control the administrator terminal 200 in accordance with an operation performed by the administrator using the operation unit 202. For example, the display unit 204 and the communication unit 206 described above are controlled by the computation unit 210. By the computation unit 210 controlling the display unit 204, for example, data stored in the storage unit 208 is appropriately displayed on the display unit 204. By the computation unit 210 controlling the communication unit 206, the administrator terminal 200 can communicate with the management apparatus 300 via the network NW.

The management apparatus 300 is a server apparatus (computer) for performing operation management of the aircraft. The management apparatus 300 is provided in, for example, a data center. The management apparatus 300 includes a communication unit 302, a storage unit 304, and a computation unit 306.

The communication unit 302 includes, for example, a communication module (not illustrated). The communication unit 302 is connected to the network NW.

The storage unit 304 may include a volatile memory (not illustrated) and a non-volatile memory (not illustrated). Examples of the volatile memory may include a RAM and the like. Examples of the non-volatile memory may include a ROM, a flash memory, and the like. Data and the like can be stored in, for example, the volatile memory. Programs, tables, maps, and the like can be stored in, for example, the non-volatile memory. At least a part of the storage unit 304 may be included in a processor, an integrated circuit, or the like, which will be described later. In addition, the storage unit 304 may further include a hard disk drive (HDD), a solid state drive (SSD), or the like.

The storage unit 304 may store information related to the plurality of users described above. Further, the storage unit 304 may store information indicating an operation plan, which will be described later. The storage unit 304 may store information related to a reservation procedure, which will be described later.

The computation unit 306 may be constituted by a processor such as a CPU or a GPU. That is, the computation unit 306 may be constituted by processing circuitry. The computation unit 306 includes a communication control unit 308, a desired operation route information acquisition unit 310, an operation plan formulation unit (operation plan acquisition unit) 312, an operation plan notification processing unit 314, a scheduled user selection unit 316, a selection result notification processing unit 318, and a return route proposal unit 320.

The communication control unit 308, the desired operation route information acquisition unit 310, the operation plan formulation unit 312, the scheduled user selection unit 316, the selection result notification processing unit 318, the operation plan notification processing unit 314, and the return route proposal unit 320 can be realized by the computation unit 306 executing a program stored in the storage unit 304. At least some of the communication control unit 308, the desired operation route information acquisition unit 310, the operation plan formulation unit 312, the scheduled user selection unit 316, the selection result notification processing unit 318, the operation plan notification processing unit 314, and the return route proposal unit 320 may be realized by an integrated circuit such as an application specific integrated circuit (ASIC) or a field-programmable gate array (FPGA). Further, at least some of the communication control unit 308, the desired operation route information acquisition unit 310, the operation plan formulation unit 312, the scheduled user selection unit 316, the selection result notification processing unit 318, the operation plan notification processing unit 314, and the return route proposal unit 320 may be constituted by an electronic circuit including a discrete device.

The communication control unit 308 controls the communication unit 302. As a result, the management apparatus 300 can communicate with the user terminal 100 via the network NW. Further, by the communication control unit 308 controlling the communication unit 302, the management apparatus 300 can communicate with the administrator terminal 200 via the network NW.

The desired operation route information acquisition unit 310 acquires desired operation route information related to a desired operation route. The desired operation route is an operation route desired by an applicant (user) who wishes to use the aircraft. The applicant can transmit the desired operation route information to the management apparatus 300 using the user terminal 100. The desired operation route information acquisition unit 310 can acquire the desired operation route information supplied from each of the plurality of user terminals 100. Therefore, the desired operation route information acquisition unit 310 can acquire a plurality of pieces of desired operation route information. The desired operation route information acquired by the desired operation route information acquisition unit 310 is stored in the storage unit 304.

The desired operation route information includes, for example, (1) desired departure place information and (2) desired arrival place information. The desired departure place information indicates a place desired by the applicant as the departure place of the aircraft. The desired arrival place information indicates a place desired by the applicant as the arrival place of the aircraft.

The desired operation route information may include (3) desired time information and (4) desired price information. The desired time information indicates a time desired by the applicant as a time when the aircraft is operated. The applicant may specify a specific date, time, or the like by using the desired time information, or may specify a relatively rough period by using the desired time information. The desired price information indicates a price range desired by the applicant for the consideration of the operation of the aircraft. In other words, the desired price information represents a cost that can be borne by the applicant for the operation of the aircraft. In the following description, the cost borne by the applicant (user) for the operation of the aircraft is also referred to as a user cost.

Note that the content of the desired operation route information is not limited to (1) to (4) described above. The desired operation route information may include information other than (1) to (4) as necessary.

The operation plan formulation unit 312 acquires an operation plan for the aircraft generated based on the plurality of pieces of desired operation route information. In the present embodiment, the operation plan formulation unit 312 formulates an operation plan for the aircraft based on the plurality of pieces of desired operation route information. The operation plan formulation unit 312 formulates the operation plan based on the plurality of pieces of desired operation route information so that the operation plan meets the desires of as many applicants as possible. For example, the operation plan formulation unit 312 selects a departure place and an arrival place that meet the desires of as many applicants as possible, based on the plurality of pieces of desired operation route information.

The operation plan formulation unit 312 may formulate an operation route to visit three or more places, based on the plurality of pieces of desired operation route information. For example, the operation plan formulation unit 312 may formulate an operation route in which the aircraft is caused to fly from a point A toward a point B and then the aircraft is caused to fly from the point B toward a point C. The user who uses the aircraft from the point A to the point B may be different from the user who uses the aircraft from the point B to the point C. By so doing, the operation plan formulation unit 312 can formulate an operation route that meets the desires of a larger number of applicants.

The operation plan formulation unit 312 may formulate an operation schedule of the aircraft based on a plurality of pieces of desired time information. The operation plan formulation unit 312 may formulate an operation schedule for visiting a plurality of places over several days. For example, the operation plan formulation unit 312 may formulate an operation schedule in which the aircraft is caused to fly from a point A toward a point B and the aircraft is caused to fly from the point B toward a point C on the next day. By so doing, the operation plan formulation unit 312 can formulate an operation schedule that meets the desires of a larger number of applicants.

Further, the longer the operation route is, the higher the cost for operating the aircraft is. For example, the longer the operation route, the more fuel the aircraft needs. The cost for operating the aircraft affects the user cost described above. In view of this, the operation plan formulation unit 312 may determine the length of the operation route based on a plurality of pieces of desired price information. By so doing, the operation plan formulation unit 312 can realize a user cost (price range) that meets the desires of as many applicants as possible.

The operation plan notification processing unit 314 performs an operation plan notification process. The operation plan notification process is a process for providing notification of the operation plan formulated by the operation plan formulation unit 312. Accordingly, the operation plan notification processing unit 314 can transmit information indicating the operation plan formulated by the operation plan formulation unit 312, to the administrator terminal 200. In addition, the operation plan notification processing unit 314 can transmit the information indicating the operation plan formulated by the operation plan formulation unit 312, to the plurality of user terminals 100. The information indicating the operation plan includes contents related to the above-described operation route, operation schedule, minimum number of passengers, and the like. The information indicating the operation plan formulated by the operation plan formulation unit 312 is appropriately transmitted from the management apparatus 300 to the plurality of user terminals 100 and the administrator terminal 200 via the network NW.

By transmitting the information indicating the operation plan to the administrator terminal 200, the administrator who manages the operation of the aircraft can grasp the operation plan formulated by the operation plan formulation unit 312. As a result, the administrator can make preparations necessary for realizing the operation plan, as necessary.

By transmitting the information indicating the operation plan to the user terminals 100, the applicants can consider whether or not to use the aircraft based on the contents of the operation plan. The applicant who wishes to use the aircraft can perform a reservation procedure. The reservation procedure is a procedure for the applicant to make a reservation for use of the aircraft. The applicant can perform the reservation procedure using the user terminal 100.

The scheduled user selection unit 316 selects users (scheduled users) who are scheduled to use an aircraft operated based on the operation plan, from among a plurality of applicants. For example, there may be a case where it is difficult for all of the applicants who have performed the above-described reservation procedure to board the aircraft due to circumstances such as an overcapacity being expected. In such a case, the scheduled user selection unit 316 selects scheduled users from among the plurality of applicants so as to be within the capacity of the aircraft. When the number of applicants who have performed the reservation procedure is equal to or less than the capacity of the aircraft, the scheduled user selection unit 316 selects, as the scheduled users, all the applicants who have performed the reservation procedure.

When selecting the scheduled user, it is preferable that the scheduled user selection unit 316 preferentially selects an applicant who has a predetermined schedule after using the aircraft. For example, the scheduled user selection unit 316 preferentially selects an applicant who has made a reservation for using a predetermined moving object. The predetermined moving object is, for example, a vehicle operated for users of the business jet. Specific examples of the vehicle include, but are not limited to, a taxi, an airport limousine, chauffeur service, and the like that are dispatched in an airport so that passengers who have got off the aircraft can quickly use the vehicle. By preferentially selecting the applicant who has reserved the use of such a moving object, the applicant can easily feel a sense of satisfaction which is difficult to obtain when using a general passenger aircraft.

Based on the information indicating the schedule of the applicant, the scheduled user selection unit 316 determines whether or not the applicant has a predetermined schedule. For example, when the applicant performs a reservation procedure, the information indicating the schedule of the applicant is transmitted to the management apparatus 300 together with the information related to the reservation procedure. However, the information indicating the schedule of the applicant may be transmitted to the management apparatus 300 as a part of the above-described desired operation route information, for example. In this case, the operation plan formulation unit 312 may preferentially reflect, in the operation plan, the contents desired by the applicant who has made a reservation for using the predetermined moving object.

The selection result notification processing unit 318 performs a selection result notification process. The selection result notification process is a process of notifying the scheduled user of the selection result of the scheduled user selection unit 316. As a result, the scheduled user can grasp that the reservation made by the scheduled user has been established. In the selection result notification process, the user other than the scheduled user may be notified of the selection result of the scheduled user selection unit 316. That is, in the selection result notification process, the applicant who has not been selected as the scheduled user may be notified that the reservation has not been established.

The return route proposal unit 320 proposes a return route for a scheduled user who is scheduled to use the aircraft operated based on the operation plan. The return route proposal unit 320 proposes the return route based on the departure place and the arrival place that are based on the operation plan. The return route proposal unit 320 may propose a return route (air route) on which the aircraft is operated or may propose a return route (land route or the like) on which a transportation means other than an aircraft is operated. The return route proposal unit 320 may propose a plurality of return routes.

Information indicating the return route proposed by the return route proposal unit 320 is transmitted to the user terminal 100 from the management apparatus 300 via the network NW. The user terminal 100 is a terminal used by the scheduled user. By proposing the return route to the scheduled user, the scheduled user is provided with convenience.

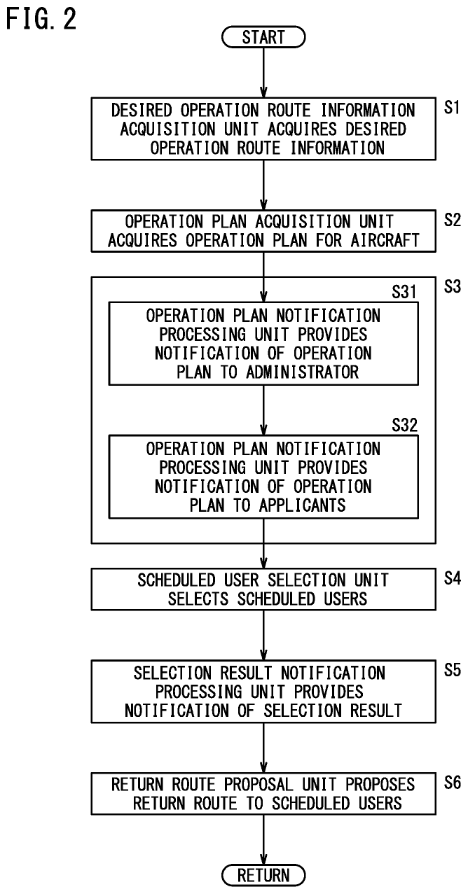

FIG. 2 is a flowchart illustrating a management method according to the present embodiment.

The management method according to the present embodiment is performed by, for example, the computation unit 306 provided in the management apparatus 300 executing a program stored in the storage unit 304. First, in step (desired operation route information acquisition step) S1, the desired operation route information acquisition unit 310 acquires the desired operation route information. The desired operation route information is provided from a plurality of applicants who use the user terminals 100. Therefore, the desired operation route information acquisition unit 310 can acquire a plurality of pieces of desired operation route information.

Next, the process proceeds to step (operation plan acquisition step) S2, and the operation plan formulation unit (operation plan acquisition unit) 312 acquires an operation plan for an aircraft. The operation plan formulation unit 312 acquires an operation plan by formulating the operation plan based on a plurality of pieces of desired operation route information.

Next, the process proceeds to step (operation plan notification step) S3. The step S3 includes a step (administrator notification step) S31 and a step (applicant notification step) S32. In step S3 (S31, S32), the operation plan notification processing unit 314 provides notification of the operation plan. The operation plan notification processing unit 314 provides notification of the operation plan to the administrator who manages the operation of the aircraft (step S31). In addition, the operation plan notification processing unit 314 provides notification of the operation plan to a plurality of applicants (step S32). The applicants who have been notified of the operation plan can perform a reservation procedure for the aircraft.

Next, the process proceeds to step (scheduled user selection step) S4, and the scheduled user selection unit 316 selects scheduled users. It is preferable that the scheduled user selection unit 316 preferentially selects, as the scheduled user, an applicant who has made a reservation for using a predetermined moving object after using the aircraft.

Next, the process proceeds to step (selection result notification step) S5, and the selection result notification processing unit 318 performs a selection result notification process. As a result, the scheduled users selected in step S4 are notified of the selection result of the scheduled user selection unit 316.

Next, the process proceeds to step (return route proposal step) S6, and the return route proposal unit 320 proposes a return route to each scheduled user. Note that the return route proposal unit 320 may propose the return route to the scheduled user only when the scheduled user desires. When the scheduled user does not want the return route proposal unit 320 to propose the return route, step S6 may be skipped. Thus, the management method illustrated in FIG. 2 ends.

According to the present embodiment, the management apparatus 300 formulates an operation plan that allows as many users as possible to use the aircraft. As a result, the management apparatus 300 can contribute to the widespread use of the aircraft. In addition, the management apparatus 300 determines the operation route and the operation schedule of the aircraft according to users' requests. In this respect, the operation management company according to the present embodiment can provide the users with an aviation service that is more convenient than that provided by a general passenger aircraft for which the operation route and the operation schedule are determined in advance. In this way, the management system 10 according to the present embodiment can contribute to the widespread use of the aircraft.

### Second Embodiment

Hereinafter, a second embodiment will be described. In the following, description overlapping with that of the first embodiment will be appropriately omitted. In the drawings used in the following description, the same components as those described in the first embodiment are denoted by the same reference numerals.

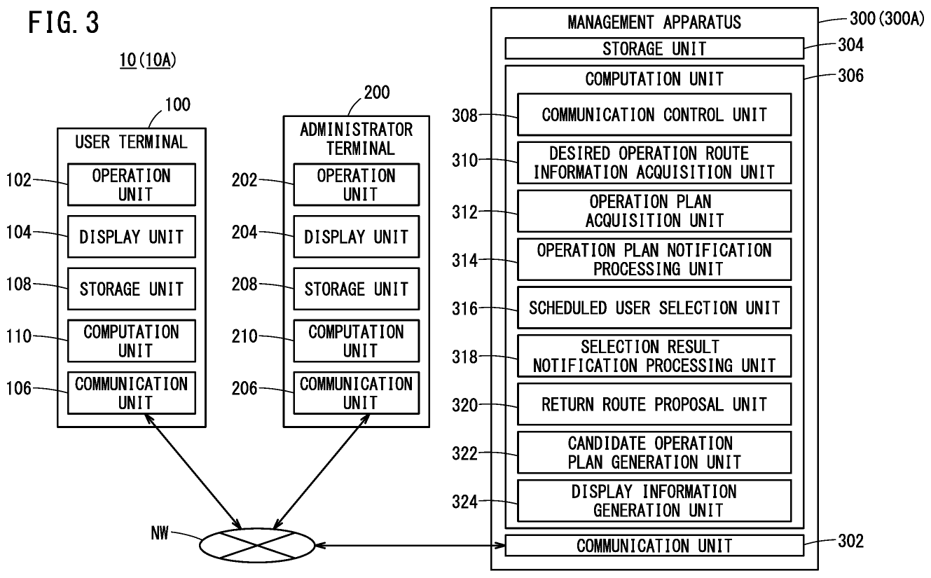

FIG. 3 is a block diagram illustrating a management system 10 (10A) according to the second embodiment.

The management system 10A includes the user terminal 100, the administrator terminal 200, and a management apparatus 300 (300A). A more detailed description of the user terminal 100 and the administrator terminal 200 will be omitted.

Similarly to the management apparatus 300 according to the first embodiment, the management apparatus 300A includes the communication unit 302, the storage unit 304, and the computation unit 306. The computation unit 306 includes the communication control unit 308, the desired operation route information acquisition unit 310, the operation plan acquisition unit 312, the operation plan notification processing unit 314, the scheduled user selection unit 316, the selection result notification processing unit 318, and the return route proposal unit 320.

As illustrated in FIG. 3, the computation unit 306 according to the present embodiment further includes a candidate operation plan generation unit 322 and a display information generation unit 324. Similarly to the communication control unit 308 and the like described above, the candidate operation plan generation unit 322 and the display information generation unit 324 are realized by, for example, the computation unit 306 executing a program stored in the storage unit 304.

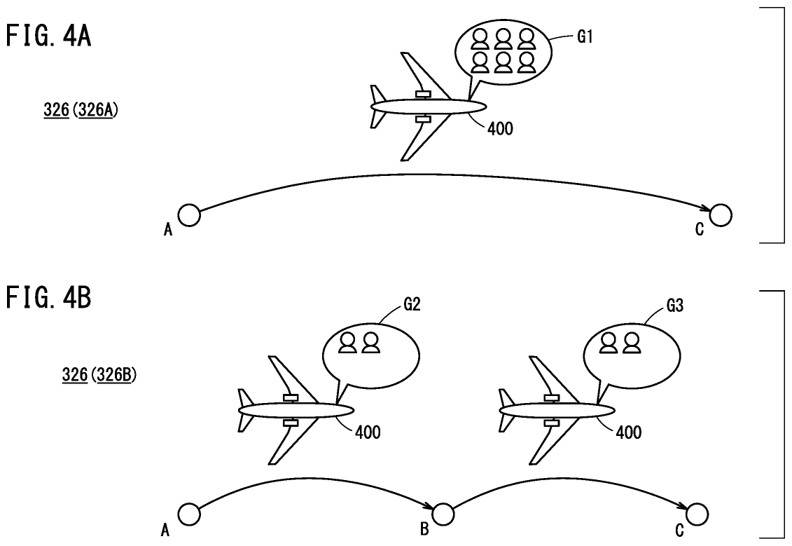

The candidate operation plan generation unit 322 generates a candidate operation plan 326 based on a plurality of pieces of desired operation route information. The candidate operation plan 326 is a candidate for an operation plan for the aircraft 400 (see also FIG. 4A and FIG. 4B). The desired operation route information includes, for example, (1) desired departure place information, (2) desired arrival place information, (3) desired time information, and (4) desired price information, and is acquired by the desired operation route information acquisition unit 310 (see also the first embodiment). The candidate operation plan generation unit 322 generates the candidate operation plan 326 based on the plurality of pieces of desired operation route information so that the candidate operation plan 326 meets the desires of as many applicants as possible. For example, the candidate operation plan generation unit 322 selects a departure place and an arrival place that meet the desires of as many applicants as possible, based on the plurality of pieces of desired operation route information. Selecting the departure place in this case may include selecting a place (initial departure place) where the first user in the daily operation schedule of the aircraft 400 boards the aircraft 400. In addition, selecting the arrival place in this case may include selecting a final arrival place (destination) of the aircraft 400 in the daily operation schedule. The candidate operation plan generation unit 322 may generate the candidate operation plan 326 to visit three or more places by the aircraft 400, based on the plurality of pieces of desired operation route information. The candidate operation plan 326 may include an operation schedule of the aircraft 400 over several days.

The candidate operation plan generation unit 322 can generate a plurality of candidate operation plans 326 for mutually different combinations of scheduled users of the aircraft 400, based on the plurality of pieces of desired operation route information.

FIG. 4A is a diagram illustrating a candidate operation plan 326A, which is an example of the candidate operation plan 326 generated by the candidate operation plan generation unit 322. FIG. 4B is a diagram illustrating a candidate operation plan 326B, which is another example of the candidate operation plan 326 generated by the candidate operation plan generation unit 322.

According to the candidate operation plan 326A of FIG. 4A, the aircraft 400 flies from a point A toward a point C after a first passenger group G1 boards the aircraft 400 at the point A. The first passenger group G1 is formed of six passengers, for example.

On the other hand, according to the candidate operation plan 326B illustrated in FIG. 4B, the aircraft 400 flies from the point A toward a point B after a second passenger group G2 boards the aircraft 400 at the point A. The second passenger group G2 is formed of two passengers, for example. Further, after the second passenger group G2 gets off the aircraft 400 at the point B, a third passenger group G3 boards the aircraft 400. The third passenger group G3 is formed of two passengers different from the two passengers of the second passenger group G2, for example. The aircraft 400 with the third passenger group G3 on board further flies from the point B toward the point C.

The display information generation unit 324 generates display information based on the plurality of candidate operation plans 326 (326A, 326B) generated by the candidate operation plan generation unit 322. The display information is information for displaying information indicating the plurality of candidate operation plans 326 on a display unit that can be visually recognized by the administrator. The display unit that can be visually recognized by the administrator is, for example, the display unit 204 provided in the administrator terminal 200.

The display information generation unit 324 generates the display information by organizing the plurality of candidate operation plans 326 based on the number of scheduled users. More specifically, the display information generation unit 324 generates the display information by organizing the plurality of candidate operation plans 326 in descending order of the number of scheduled users.

For example, a case will be described where the operation date of the aircraft 400 according to the candidate operation plan 326A (FIG. 4A) and the operation date of the aircraft 400 according to the candidate operation plan 326B (FIG. 4B) are the same, and the candidate operation plan 326A and the candidate operation plan 326B are incompatible. As described above, the total number of the scheduled users (passengers) based on the candidate operation plan 326A is six. The total number of the scheduled users (passengers) based on the candidate operation plan 326B is four.

In such a case, for example, the display information generation unit 324 generates the display information such that the candidate operation plan 326A is displayed at a higher level than the candidate operation plan 326B when the plurality of candidate operation plans 326 are listed on the display unit 204 in a list format. In addition, for example, based on the number of scheduled users, the display information generation unit 324 may make the display modes of the information indicating the plurality of candidate operation plans 326 different from each other on the display unit 204. More specifically, for example, the display information generation unit 324 may make the font of the characters displayed on the display unit 204 for indicating the candidate operation plan 326A different from the font of the characters displayed on the display unit 204 for indicating the candidate operation plan 326B. The display information generation unit 324 may make the graphic displayed on the display unit 204 for indicating the candidate operation plan 326A different from the graphic displayed on the display unit 204 for indicating the candidate operation plan 326B.

The display information generated by the display information generation unit 324 can be transmitted to the administrator terminal 200 via the communication unit 302. In this case, information indicating the plurality of candidate operation plans 326 can be displayed on the display unit 204 provided in the administrator terminal 200 based on the display information transmitted to the administrator terminal 200. The administrator can arbitrarily select one of the plurality of candidate operation plans 326 displayed on the display unit 204 via the operation unit 202 provided in the administrator terminal 200.

As described above, the display information generation unit 324 generates the display information by organizing the plurality of candidate operation plans 326 based on the number of applicants. By so doing, the administrator is prompted to select the candidate operation plan 326 for which the number of applicants is relatively large. More specifically, the administrator is prompted to select the candidate operation plan 326A from among the candidate operation plan 326A and the candidate operation plan 326B. It should be noted that the administrator is allowed to select the candidate operation plan 326 for which the number of applicants is relatively small. For example, in the above example, the administrator is allowed to select the candidate operation plan 326B instead of the candidate operation plan 326A.

The information indicating the selection result of the administrator is transmitted from the administrator terminal 200 to the management apparatus 300A via the communication unit 206 provided in the administrator terminal 200. The information indicating the selection result is information indicating the candidate operation plan 326 selected via the administrator terminal 200 from among the plurality of candidate operation plans 326.

The operation plan acquisition unit 312 acquires the operation plan for the aircraft 400 based on the information indicating the selection result transmitted from the administrator terminal 200. That is, the operation plan acquisition unit 312 acquires, as a formal operation plan, the candidate operation plan 326 selected via the administrator terminal 200 from among the plurality of candidate operation plans 326.

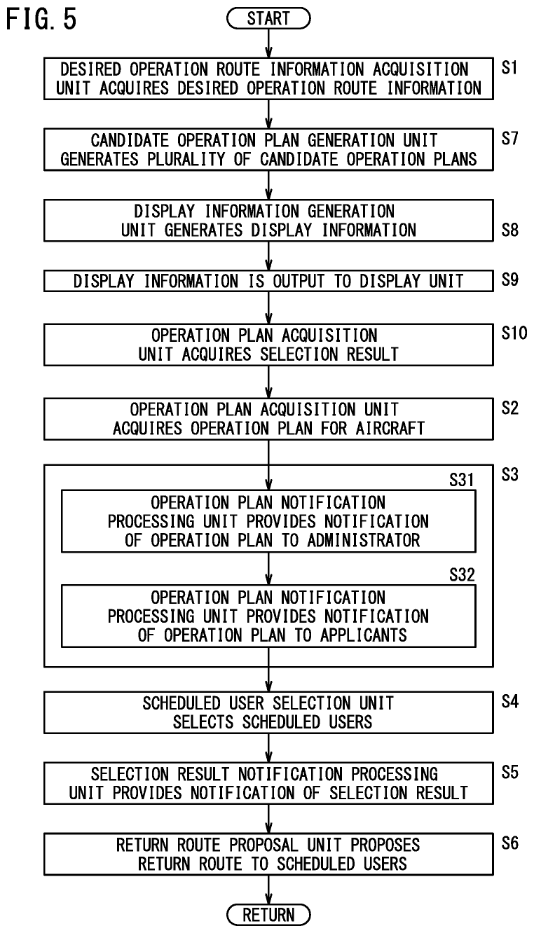

FIG. 5 is a flowchart illustrating a management method according to the second embodiment.

The management method according to the present embodiment is performed by, for example, the computation unit 306 provided in the management apparatus 300A executing a program stored in the storage unit 304. First, in step (desired operation route information acquisition step) S1, the desired operation route information acquisition unit 310 acquires the desired operation route information. The desired operation route information is provided from a plurality of applicants who use the user terminals 100. Therefore, the desired operation route information acquisition unit 310 can acquire a plurality of pieces of desired operation route information.

Next, the process proceeds to step (candidate operation plan generation step) S7, and the candidate operation plan generation unit 322 generates a plurality of candidate operation plans 326. The candidate operation plans 326 are generated based on a plurality of pieces of desired operation route information. The plurality of candidate operation plans 326 are different from each other in combinations of scheduled users of the aircraft 400.

Next, the process proceeds to step (display information generation step) S8, and the display information generation unit 324 generates display information based on the plurality of candidate operation plans 326. The display information generation unit 324 generates the display information by organizing the plurality of candidate operation plans 326 based on the number of applicants.

Next, the process proceeds to step (output step) S9, and the display information generated in step S8 is output to the display unit (display unit 204) that can be visually recognized by the administrator. For example, the communication control unit 308 causes the display information to be transmitted to the administrator terminal 200 in which the display unit 204 is provided. As a result, the information indicating the plurality of candidate operation plans 326 is displayed on the display unit 204 based on the display information.

Next, the process proceeds to step (selection result acquisition step) S10, and information indicating the candidate operation plan 326 (selection result) selected by the administrator is acquired by the operation plan acquisition unit 312. The information indicating the selection result can be transmitted from the administrator terminal 200 to the management apparatus 300A via the network NW.

Next, the process proceeds to step (operation plan acquisition step) S2, and the operation plan acquisition unit 312 acquires the operation plan for the aircraft 400 based on the information indicating the selection result acquired in step S10. The operation plan acquisition unit 312 acquires, as a formal operation plan, the candidate operation plan 326 selected by the administrator.

Next, step S3 to step S6 can be sequentially executed as in the first embodiment. In the case of the present embodiment, the contents of the operation plan determined based on the selection result of the administrator are obvious to this administrator. Therefore, in the present embodiment, the step (administrator notification step) S31 may be skipped.

According to the present embodiment, the management apparatus 300A can promote the formulation of an operation plan for which the number of scheduled users of the aircraft 400 is as large as possible. As a result, it is possible to provide more users with the flight experience. That is, it is possible to maximize the number of users who experience the use of the aircraft 400. As a result, the management apparatus 300A can contribute to the widespread use of the aircraft 400.

### Modified Embodiment

Based on a plurality of pieces of desired operation route information, the operation plan formulation unit 312 may select a departure place that is not indicated in any of the plurality of pieces of desired operation route information. For example, a point U is indicated in the desired operation route information (desired departure place information) provided by a certain user, and a point V is indicated in the desired operation route information (desired departure place information) provided by another certain user. In a case where the point U and the point V are relatively close to each other, if a point W between the point U and the point V is set as a departure place, there is a possibility that both of the above-described two users can board the aircraft from the point W. Based on this, in a case where a distance between a plurality of candidate departure places indicated in a plurality of pieces of desired operation route information (desired departure place information) is within a predetermined distance, the operation plan formulation unit 312 may select, as a departure place, a place between the plurality of candidate departure places. The same applies to a case where the candidate operation plan 326 is generated by the candidate operation plan generation unit 322.

In a case where a distance between a plurality of candidate arrival places indicated in a plurality of pieces of desired operation route information (desired arrival place information) is within a predetermined distance, the operation plan formulation unit 312 may select, as an arrival place, a place between the plurality of candidate arrival places. For example, a point X is indicated in the desired operation route information (desired arrival place information) provided by a certain user, and a point Y is indicated in the desired operation route information (desired arrival place information) provided by another certain user. In a case where the point X and the point Y are relatively close to each other, a point Z between the point X and the point Y may be selected as an arrival place. The same applies to a case where the candidate operation plan 326 is generated by the candidate operation plan generation unit 322.

Users may use the aircraft not only for boarding, but also for transporting supplies. The user may include, in the desired operation route information, information indicating that the user wishes to use only the cargo compartment out of the passenger compartment and the cargo compartment provided in the aircraft.

The operation plan formulation unit 312 may formulate an operation plan based on a plurality of pieces of desired operation route information such that the number of users who experience the use of the aircraft is maximized. As a result, it is possible to provide more users with the flight experience.

In the following description, the plurality of candidate operation plans 326 for which the numbers of the scheduled users are the same are also referred to as a plurality of candidate operation plans with the same number of users. The candidate operation plan generation unit 322 may generate a plurality of candidate operation plans with the same number of users, based on a plurality of pieces of desired operation route information. In this case, the display information generation unit 324 preferably generates the display information by organizing the plurality of candidate operation plans with the same number of users based on the number of take-offs and landings of the aircraft 400. This promotes the administrator to select the candidate operation plan 326 in which the number of take-offs and landings of the aircraft 400 is reduced as much as possible. By reducing the number of take-offs and landings of the aircraft 400, for example, the operation management company can suppress costs including a usage fee or the like for departure and arrival places (airports) of the aircraft 400. In this case, the display information generation unit 324 can generate the display information by organizing the plurality of candidate operation plans 326 based on both the number of applicants and the number of take-offs and landings of the aircraft 400. As a result, information indicating the plurality of candidate operation plans 326 organized based on the number of applicants can be displayed on the display unit 204 that can be visually recognized by the administrator. In addition, the plurality of candidate operation plans with the same number of users included in the plurality of candidate operation plans 326 can be displayed on the display unit 204 in a state of being organized based on the number of take-offs and landings of the aircraft 400.

The display unit that can be visually recognized by the administrator is not limited to the display unit 204 provided in the administrator terminal 200. For example, a display (not illustrated) appropriately provided in the management apparatus 300A may be used as the display unit that can be visually recognized by the administrator. In this case, an input device (not illustrated) appropriately provided in the management apparatus 300A may be used as an operation unit for inputting the selection result to the management apparatus 300A.

The following notes (appendices) are further disclosed in relation to the above-described embodiments.

### APPENDIX 1

The management apparatus (300) according to the present disclosure includes: the desired operation route information acquisition unit (310) configured to acquire desired operation route information indicating a desired operation route that is an operation route desired by an applicant who wishes to use the aircraft (400); and the operation plan acquisition unit (312) configured to acquire an operation plan for the aircraft generated based on a plurality of pieces of the desired operation route information. According to this feature, it is possible to contribute to the widespread use of the aircraft.

### APPENDIX 2

The management apparatus according to Appendix 1 may further include the scheduled user selection unit (316) configured to select, from among a plurality of the applicants, a scheduled user who is scheduled to use the aircraft operated based on the operation plan. According to this feature, it is possible to prevent the aircraft from becoming inoperable due to a situation such as overcapacity.

### APPENDIX 3

In the management apparatus according to Appendix 1 or 2, the scheduled user selection unit may preferentially select the applicant who has made a reservation for using a predetermined moving object after using the aircraft. According to this feature, it is possible to make the applicant feel a sense of satisfaction close to that in the case of using a business jet. As a result, the widespread use of business jets can be promoted.

### APPENDIX 4

The management apparatus according to any one of Appendices 1 to 3 may further include the selection result notification processing unit (318) configured to perform a process of providing notification of the selection result of the scheduled user selection unit to the scheduled user.

### APPENDIX 5

The management apparatus according to any one of Appendices 1 to 4 may further include the operation plan notification processing unit (314) configured to perform a process of providing notification of the operation plan to the administrator of the aircraft.

### APPENDIX 6

The management apparatus according to any one of Appendices 1 to 5 may further include the return route proposal unit (320) configured to propose a return route for the scheduled user who is scheduled to use the aircraft operated based on the operation plan. According to this feature, the scheduled user is provided with convenience.

### APPENDIX 7

The management apparatus according to Appendix 1 may further include: the candidate operation plan generation unit (322) configured to generate, based on the plurality of pieces of desired operation route information, a plurality of candidate operation plans (326) for mutually different combinations of scheduled users who are scheduled to use the aircraft; and the display information generation unit (324) configured to generate display information that is information for displaying information indicating the plurality of candidate operation plans on the display unit visually recognizable by the administrator of the aircraft, wherein the display information generation unit may generate the display information by organizing the plurality of candidate operation plans based on the number of the scheduled users, and the operation plan acquisition unit may acquire, as the operation plan, one candidate operation plan selected from among the plurality of candidate operation plans indicated by the display information. According to this feature, it is possible to increase the number of users who experience the use of the aircraft as much as possible, which can contribute to the widespread use of the aircraft.

### APPENDIX 8

In the management apparatus according to Appendix 7, the display information generation unit may generate the display information in a manner so that the plurality of candidate operation plans are displayed in descending order of the number of the scheduled users. According to this feature, selection of the candidate operation plan having a relatively large number of scheduled users is promoted, and thus it is possible to increase the number of users who experience the use of the aircraft as much as possible.

### APPENDIX 9

In the management apparatus according to Appendix 7, the plurality of candidate operation plans for which numbers of the scheduled users are same are defined as a plurality of candidate operation plans with a same number of users, and in a case where the candidate operation plan generation unit generates the plurality of candidate operation plans with the same number of the users, the display information generation unit may generate the display information by organizing the plurality of candidate operation plans with the same number of the users based on the number of take-offs and landings of the aircraft. According to this feature, selection of the candidate operation plan in which the number of take-offs and landings is reduced as much as possible is promoted, and thus it is possible to suppress the operation cost of the aircraft.

### APPENDIX 10

In the management apparatus according to Appendix 1, the operation plan acquisition unit may formulate the operation plan based on the plurality of pieces of desired operation route information in a manner so that the number of scheduled users who experience the use of the aircraft is maximized. The operation plan is formulated such that the number of users who experience the use of the aircraft is maximized, which contributes to the widespread use of the aircraft.

### APPENDIX 11

The management method according to the present disclosure is a management method executed by a computer, the management method including: the desired operation route information acquisition step (S1) of acquiring desired operation route information indicating a desired operation route that is an operation route of an aircraft desired by an applicant who wishes to use the aircraft; and the operation plan acquisition step (S2) of acquiring an operation plan for the aircraft generated based on a plurality of pieces of the desired operation route information. According to this feature, it is possible to contribute to the widespread use of the aircraft.

### APPENDIX 12

The management method according to Appendix 11 may further include: the candidate operation plan generation step (S7) of generating, based on the plurality of pieces of desired operation route information, a plurality of candidate operation plans for mutually different combinations of scheduled users who are scheduled to use the aircraft; and the display information generation step (S8) of generating display information that is information for displaying information indicating the plurality of candidate operation plans on the display unit visually recognizable by the administrator of the aircraft, wherein in the display information generation step, the display information may be generated by organizing the plurality of candidate operation plans based on the number of the scheduled users, and in the operation plan acquisition step, one candidate operation plan selected from among the plurality of candidate operation plans indicated by the display information may be acquired as the operation plan. According to this feature, it is possible to increase the number of users who experience the use of the aircraft as much as possible, which can contribute to the widespread use of the aircraft.

### APPENDIX 13

The storage medium according to the present disclosure is a non-transitory computer-readable storage medium that stores a program for causing a computer to execute the management method according to Appendix 11 or 12. According to this feature, it is possible to contribute to the widespread use of the aircraft.

It should be noted that the present invention is not limited to the disclosure described above, and various configurations can be adopted therein without departing from the essence and gist of the present invention.

1. A management apparatus comprising one or more processors that execute computer-executable instructions stored in a memory,
wherein the one or more processors execute the computer-executable instructions to cause the management apparatus to:
acquire desired operation route information indicating a desired operation route that is an operation route desired by an applicant who wishes to use an aircraft; and
acquire an operation plan for the aircraft generated based on a plurality of pieces of the desired operation route information.

2. The management apparatus according to claim 1, wherein
the one or more processors cause the management apparatus to select, from among a plurality of the applicants, a scheduled user who is scheduled to use the aircraft operated based on the operation plan.

3. The management apparatus according to claim 2, wherein
the one or more processors cause the management apparatus to preferentially select the applicant who has made a reservation for using a predetermined moving object after using the aircraft.

4. The management apparatus according to claim 2, wherein
the one or more processors cause the management apparatus to perform a process of providing notification of a result of selection of the scheduled user, to the scheduled user.

5. The management apparatus according to claim 1, wherein the one or more processors cause the management apparatus to perform a process of providing notification of the operation plan to an administrator of the aircraft.

6. The management apparatus according to claim 1, wherein
the one or more processors cause the management apparatus to propose a return route for a scheduled user who is scheduled to use the aircraft operated based on the operation plan.

7. The management apparatus according to claim 1, wherein
the one or more processors cause the management apparatus to:
generate, based on the plurality of pieces of desired operation route information, a plurality of candidate operation plans for mutually different combinations of scheduled users who are scheduled to use the aircraft;
generate display information that is information for displaying information indicating the plurality of candidate operation plans on a display unit visually recognizable by an administrator of the aircraft;
generate the display information by organizing the plurality of candidate operation plans based on a number of the scheduled users; and
acquire, as the operation plan, one candidate operation plan selected from among the plurality of candidate operation plans indicated by the display information.

8. The management apparatus according to claim 7, wherein
the one or more processors cause the management apparatus to generate the display information in a manner so that the plurality of candidate operation plans are displayed in descending order of the number of the scheduled users.

9. The management apparatus according to claim 7, wherein
the plurality of candidate operation plans for which numbers of the scheduled users are same are defined as a plurality of candidate operation plans with a same number of users, and in a case where the plurality of candidate operation plans with the same number of the users are generated, the one or more processors cause the management apparatus to generate the display information by organizing the plurality of candidate operation plans with the same number of the users based on a number of take-offs and landings of the aircraft.

10. The management apparatus according to claim 1, wherein
the one or more processors cause the management apparatus to formulate the operation plan based on the plurality of pieces of desired operation route information in a manner so that a number of scheduled users who experience use of the aircraft is maximized.

11. A management method executed by a computer, the method comprising:
acquiring desired operation route information indicating a desired operation route that is an operation route of an aircraft desired by an applicant who wishes to use the aircraft; and
acquiring an operation plan for the aircraft generated based on a plurality of pieces of the desired operation route information.

12. The management method according to claim 11, further comprising:
generating, based on the plurality of pieces of desired operation route information, a plurality of candidate operation plans for mutually different combinations of scheduled users who are scheduled to use the aircraft; and
generating display information that is information for displaying information indicating the plurality of candidate operation plans on a display unit visually recognizable by an administrator of the aircraft, wherein
in the generating of the display information, the display information is generated by organizing the plurality of candidate operation plans based on a number of the scheduled users, and
in the acquiring of the operation plan, one candidate operation plan selected from among the plurality of candidate operation plans indicated by the display information is acquired as the operation plan.

13. A non-transitory computer-readable storage medium that stores a program,
wherein the program causes a computer to execute the management method according to claim 11.
